(19) United States
(12) Patent Application Publication
(10) Pub. No.: US 2019/0156417 A1
(43) Pub. Date: May 23, 2019

(54) MODELING METHOD AND DEVICE FOR EVALUATION MODEL

(71) Applicant: Alibaba Group Holding Limited, George Town (KY)

(72) Inventors: Xing ZHAO, Hangzhou (CN); Wei DU, Hangzhou (CN)

(73) Assignee: Alibaba Group Holding Limited, George Town (KY)

(21) Appl. No.: 16/251,741

(22) Filed: Jan. 18, 2019

Related U.S. Application Data
(63) Continuation of application No. PCT/CN2017/092912, filed on Jul. 14, 2017.

(30) Foreign Application Priority Data
Jul. 21, 2016 (CN) 201610581457.5

(51) Int. Cl. G06Q 40/02; G06Q 10/04; G06N 20/00; G06N 3/08

(52) U.S. Cl. CPC G06Q 40/025; G06N 3/08; G06N 20/00; G06Q 10/04

(57) ABSTRACT

At a serving end, modeling samples from a number of modeling scenarios are separately collected, where each modeling sample includes a scenario variable and several basic variables, and where the scenario variable indicates a modeling scenario that the modeling sample belongs to. A modeling sample set is generated by merging the modeling samples. An evaluation model is trained based on modeling samples in the modeling sample set to generate a trained evaluation model, where the trained evaluation model is universal, and where the trained evaluation model is configured to produce a score applicable to multiple service scenarios.

### CROSS-REFERENCE TO RELATED APPLICATIONS

This application is a continuation of PCT Application No. PCT/CN2017/092912, filed on Jul. 14, 2017, which claims priority to Chinese Patent Application No. 201610581457.5, filed on Jul. 21, 2016, and each application is hereby incorporated by reference in its entirety.

### TECHNICAL FIELD

The present application relates to the field of computer applications, and in particular, to a modeling method and device for an evaluation model.

### BACKGROUND

A service risk model is an evaluation model used to perform service risk evaluation. In the related technologies, a large amount of service data can usually be collected from a certain service scenario as modeling samples, and the modeling samples are classified based on whether the modeling samples include a predefined service risk event. Then, the modeling samples are trained by using a statistics collection model or a machine learning method to build a service risk model.

After the service risk model is built, target service data can be input into the service risk model to perform risk evaluation and to predict the probability of the service risk event. Then, the probability is converted into a corresponding service score, to reflect a service risk level.

However, in practice, when there are a relatively large number of service scenarios, a service score obtained by performing service risk evaluation using a service risk model built for a single scenario is usually not universal, and therefore is inapplicable to multiple different service scenarios.

### SUMMARY

The present application provides a modeling method for an evaluation model, where the method includes: separately collecting modeling samples from multiple modeling scenarios, where the modeling sample includes a scenario variable and several basic variables, and the scenario variable indicates a modeling scenario that the modeling sample belongs to; creating a modeling sample set based on the modeling samples collected from the multiple modeling scenarios; and training an evaluation model based on the modeling samples in the modeling sample set, where the evaluation model is an additive model, and the evaluation model is obtained by adding a model portion formed by basic variables and a model portion formed by scenario variables.

Optionally, the method further includes: defining a training sample weight for each modeling scenario based on a number of modeling samples in each modeling scenario, where the training sample weight is used to balance a modeling sample number difference between the modeling scenarios, and a smaller number of modeling samples in a modeling scenario indicates that a larger training sample weight is defined for the scenario.

Optionally, the method further includes: collecting target data, where the target data includes a scenario variable and several basic variables; and inputting the target data into the evaluation model to obtain a target data score, where the score is obtained by adding corresponding scores of the several basic variables in the evaluation model and a corresponding score of the scenario variable in the evaluation model.

Optionally, the method further includes: outputting a sum of the corresponding scores of the several basic variables in the evaluation model and the corresponding score of the scenario variable in the evaluation model as a score applicable to a modeling scenario that the target data belongs to, if the target data needs to be scored in the modeling scenario that the target data belongs to.

Optionally, the method further includes: outputting the corresponding scores of the several basic variables in the evaluation model as a score applicable to the multiple modeling scenarios, if the target data needs to be scored in the multiple modeling scenarios.

The present application further provides a modeling device for an evaluation model, where the device includes a collection module, configured to separately collect modeling samples from multiple modeling scenarios, where the modeling sample includes a scenario variable and several basic variables, and the scenario variable indicates a modeling scenario that the modeling sample belongs to; a creation module, configured to create a modeling sample set based on the modeling samples collected from the multiple modeling scenarios; and a training module, configured to train an evaluation model based on the modeling samples in the modeling sample set, where the evaluation model is an additive model, and the evaluation model is obtained by adding a model portion formed by basic variables and a model portion formed by scenario variables.

Optionally, the creation module is further configured to define a training sample weight for each modeling scenario based on a number of modeling samples in each modeling scenario, where the training sample weight is used to balance a modeling sample number difference between the modeling scenarios, and a smaller number of modeling samples in a modeling scenario indicates that a larger training sample weight is defined for the scenario.

Optionally, the collection module is further configured to collect target data, where the target data includes a scenario variable and several basic variables.

The device further includes a scoring module, configured to input the target data into the evaluation model, to obtain a target data score, where the score is obtained by adding corresponding scores of the several basic variables in the evaluation model and a corresponding score of the scenario variable in the evaluation model.

Optionally, the scoring module is further configured to output a sum of the corresponding scores of the several basic variables in the evaluation model and the corresponding score of the scenario variable in the evaluation model as a score applicable to a modeling scenario that the target data belongs to, if the target data needs to be scored in the modeling scenario that the target data belongs to.

Optionally, the scoring module is further configured to output the corresponding scores of the several basic variables in the evaluation model as a score applicable to the multiple modeling scenarios, if the target data needs to be scored in the multiple modeling scenarios.

In the present application, the modeling samples are separately collected from the multiple modeling scenarios, the modeling sample set is created based on the modeling samples collected from the multiple service scenarios, and the scenario variables used to indicate the modeling scenarios that the modeling samples belong to are separately defined for the modeling samples in the modeling sample set based on the original basic variables, and then the evaluation model is trained based on the modeling samples in the modeling sample set. In the present application, the modeling samples in the multiple service scenarios are merged for modeling, and the scenario variables are used for the modeling samples to distinguish between the scenarios of the modeling samples. Therefore, the final trained evaluation model is universal, and therefore a score applicable to multiple different service scenarios can be obtained by using the evaluation model.

### BRIEF DESCRIPTION OF DRAWINGS

FIG. 1 is a flowchart illustrating a modeling method for an evaluation model, according to an implementation of the present application;

FIG. 2 is a flowchart illustrating that modeling samples in multiple service scenarios are merged to train an evaluation model, according to an implementation of the present application;

FIG. 3 is a logical block diagram illustrating a modeling device for an evaluation model, according to an implementation of the present application;

FIG. 4 is a structural diagram illustrating hardware of a serving end that includes a modeling device for an evaluation model, according to an implementation of the present application; and

FIG. 5 is a flowchart illustrating an example of a computer-implemented method for generating and training an evaluation model, according to an implementation of the present disclosure.

### DESCRIPTION OF IMPLEMENTATIONS

In practice, when service risk evaluation is performed for multiple different service scenarios, it is usually expected that a trained evaluation model is applicable to the different service scenarios.

For example, when the service is a loan service, the evaluation model can usually be a credit risk evaluation model, and the multiple different service scenarios can include different loan service scenarios such as credit card services, mortgage services, and car loan services. In this case, it is usually expected that a credit score obtained by performing service risk evaluation by using the credit risk evaluation model can be universal, and therefore the credit risk evaluation model has better performance in different scenarios such as loan services, credit card services, and consumer finance services.

In the related technologies, to resolve the previously described problem, there are usually the following modeling methods:

Method 1: A risk evaluation model can be trained based on modeling samples collected from a single service scenario, and then a score obtained by using the evaluation model is directly applied to other service scenarios. In this solution, because no other service scenario is considered during model training, the service score obtained by using the service risk model trained in the single scenario is not universal, and therefore performance of the service risk model in other service scenarios cannot be ensured.

Method 2: Evaluation models can be separately trained based on modeling samples collected from multiple different service scenarios, and service risk evaluation is separately performed by using the evaluation models trained in the service scenarios, to obtain scores. Then, weighted averaging is performed on the scores obtained by using the evaluation models. In this solution, although universality of a final score obtained through weighted averaging in multiple service scenarios is improved, more service scenarios indicates more complex model training and management because a model needs to be trained for each service scenario.

Method 3: Evaluation models can still be separately trained based on modeling samples collected from multiple different service scenarios, and then the evaluation models trained in the service scenarios are combined. In this solution, a model still needs to be trained for each service scenario, and therefore multiple models need to be maintained simultaneously. Also, more service scenarios indicate more complex model training and management. In addition, if a relatively complex modeling algorithm is used for model training, for example, a neural network algorithm is used for model training, the evaluation models trained in the service scenarios cannot be simply combined, and therefore the implementation is relatively complex.

In view of this, the present application provides a modeling method for an evaluation model:

Modeling samples are separately collected from multiple modeling scenarios, a modeling sample set is created based on the modeling samples collected from the multiple scenarios, and scenario variables used to indicate the modeling scenarios that the modeling samples belong to are separately defined for the modeling samples in the modeling sample set based on original basic variables, and then an evaluation model is trained based on the modeling samples in the modeling sample set.

In the present application, the modeling samples in the multiple scenarios are merged for modeling, and the scenario variables are used for the modeling samples to distinguish between the scenarios of the modeling samples. Therefore, the final trained evaluation model is universal, and therefore a score applicable to multiple different service scenarios can be obtained by using the evaluation model.

The following describes the present application by using specific implementations and with reference to specific application scenarios.

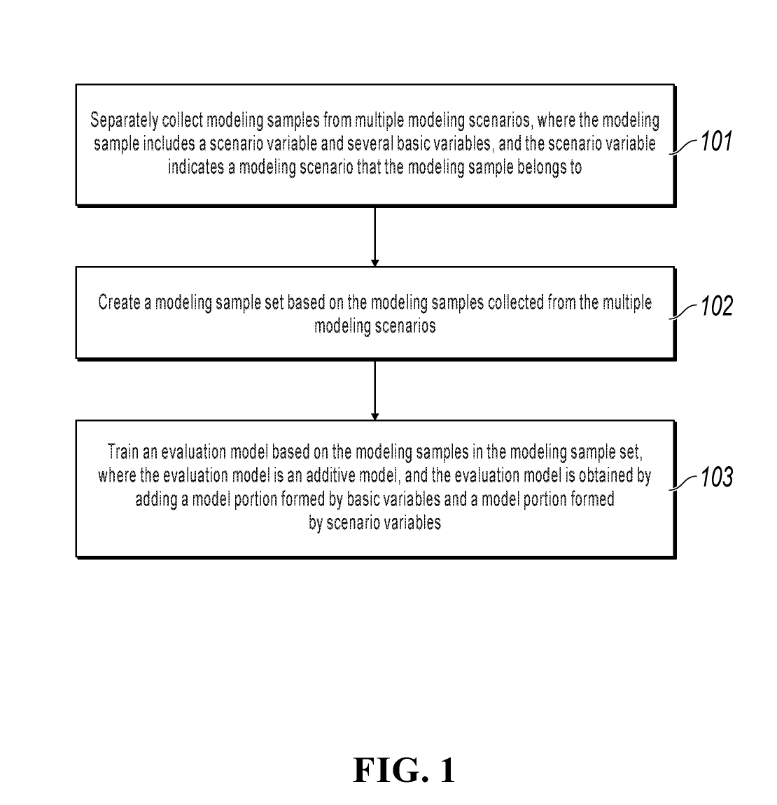

Referring to FIG. 1, FIG. 1 shows a modeling method for an evaluation model, according to an implementation of the present application. The method is applied to a serving end, and the method includes the following steps:

Step 101: Separately collect modeling samples from multiple modeling scenarios, where the modeling sample includes a scenario variable and several basic variables, and the scenario variable indicates a modeling scenario that the modeling sample belongs to.

Step 102: Create a modeling sample set based on the modeling samples collected from the multiple modeling scenarios.

Step 103: Train an evaluation model based on the modeling samples in the modeling sample set, where the evaluation model is an additive model, and the evaluation model is obtained by adding a model formed by basic variables and a model formed by scenario variables.

The serving end can include a server, a server cluster, or a cloud platform built based on a server cluster, configured to train an evaluation model.

The evaluation model is an additive model built after a large number of collected modeling samples are trained. For example, risk evaluation is performed on a user. The evaluation model can be used to perform risk evaluation on target data collected from a particular service scenario, to obtain a user score. The user score is used to measure the service risk probability in a future period of time.

For example, when the service is a loan service, the evaluation model can be a credit risk evaluation model. The credit risk evaluation model can be used to perform credit risk evaluation on a service sample collected from a particular loan service scenario, to obtain a corresponding credit score. The credit score is used to measure the credit default probability of a user in a future period of time.

In practice, the modeling sample and the target data each can include several basic variables that have relatively large impact on a service risk.

For example, when the evaluation model is a credit risk evaluation model, the basic variables included in the modeling sample and the target data can be variables that affect a credit risk. For example, the variables that affect a credit risk can include income spending data of the user, historical loan data, and the employment status of the user.

Selection of the basic variables included in the modeling sample and the target data is not limited in this example. When implementing the technical solutions described in the present application, a person skilled in the art can make references to literatures in the related technologies.

In this example, when training an evaluation model, the serving end can separately collect modeling samples from multiple service scenarios, and further use scenario variables based on original basic variables included in the modeling samples collected from the multiple different service scenarios.

Each of the multiple service scenarios can be referred to as a modeling scenario. The used scenario variables are used to indicate modeling scenarios (namely, the service scenarios) that the modeling samples belong to.

After the scenario variables are used for the modeling samples in the service scenarios, the modeling samples in the multiple different service scenarios can be merged for modeling. As such, modeling complexity can be reduced. In addition, the trained service risk model is universal, and therefore is applicable to multiple different service scenarios.

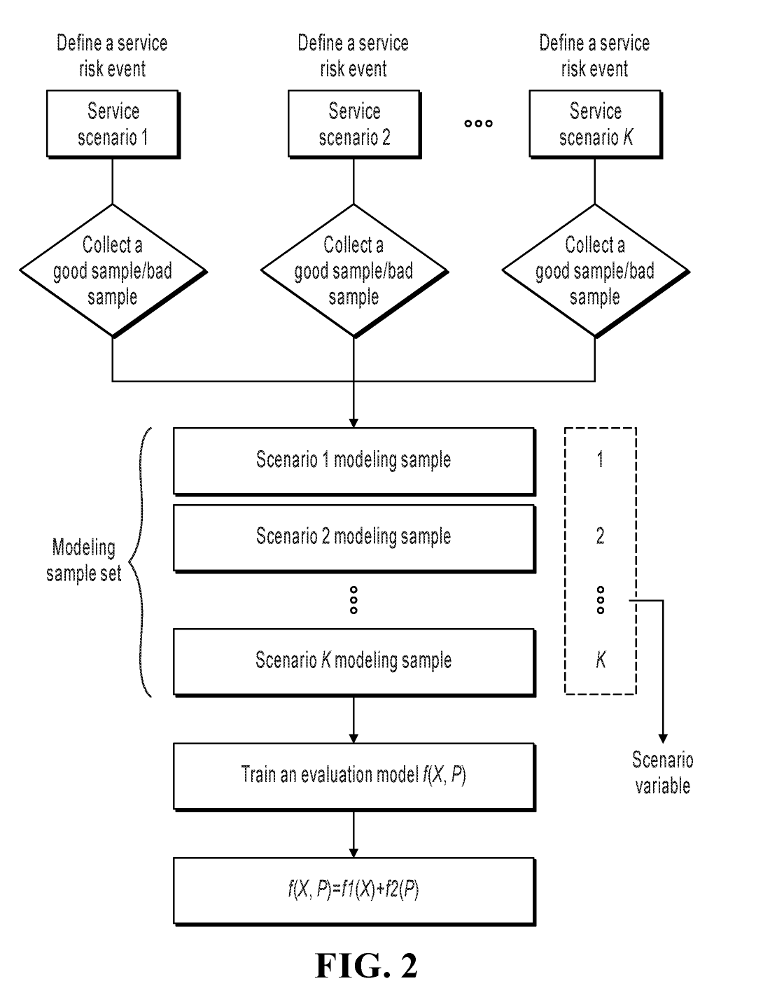

Referring to FIG. 2, FIG. 2 is a schematic diagram illustrating that modeling samples in multiple different service scenarios are merged for modeling in this example.

Risk events are separately defined for service scenarios, and risk events defined for different service scenarios can be independent of each other and different from each other.

For example, when the service is a loan service, a credit default event can usually be defined as a risk event in different loan service scenarios such as credit card services, mortgage services, and car loan services, and definitions of the credit default event in different loan scenarios can be different from each other. For example, in a credit card crediting scenario, an over-30-day deferred repayment event can be defined as the credit default event. In a mortgage crediting scenario, an over-90-day deferred repayment event can be defined as the credit default event. In a car loan crediting scenario, an over-60-day deferred repayment event can be defined as the credit default event. In other words, the credit default event can be independently defined for each loan scenario.

After the risk events are separately defined for the service scenarios, the serving end can separately collect modeling samples from the service scenarios, and classify the modeling samples collected from the service scenarios into good samples and bad samples by determining whether the collected modeling samples include the risk events that are separately defined for the service scenarios.

When the modeling samples include only good samples or bad samples, an evaluation model that is completely trained is usually not accurate enough. Therefore, the modeling samples can be enriched by classifying the collected modeling samples into the good samples and the bad samples, so that the good samples and the bad samples separately account for certain proportions of the modeling samples. This can improve accuracy of the final trained evaluation model during service risk evaluation.

In this example, after collecting a certain number of modeling samples from the service scenarios, the serving end merges the modeling samples collected from the service scenarios for model training, instead of separately performing modeling for the service scenarios.

Referring to FIG. 2, when merging the modeling samples collected from the service scenarios, the serving end can summarize the modeling samples collected from the service scenarios to generate a modeling sample set. The modeling sample set includes the modeling samples collected from the service scenarios.

The modeling sample in the modeling sample set includes a scenario variable used to indicate a modeling scenario.

In a shown implementation, the scenario variable can be specifically a quantized label value. For example, a corresponding label value can be defined for each service scenario. For example, as shown in FIG. 2, label value 1 can be defined for a modeling sample from scenario 1 to indicate that the modeling sample is from scenario 1, and label value 2 can be defined for a modeling sample from scenario 2 to indicate that the modeling sample is from scenario 2.

When the serving end defines a scenario variable for a modeling sample, in an implementation, the serving end can define a scenario variable for a modeling sample as soon as the modeling sample is collected from the service scenarios; and in another implementation, the serving end can define a scenario variable for each modeling sample in the modeling sample set after the modeling model set is generated based on the modeling samples collected from the service scenarios. Implementations are not limited in this example.

In a shown implementation, because the number of modeling samples collected by the serving end from the service scenarios may be different from each other, the serving end can define a training sample weight for each service scenario based on a number of modeling samples collected from each service scenario.

The training sample weight is used to balance a modeling sample number difference between the service scenarios. In practice, the training sample weight can be a weight value that can represent a number of modeling samples in each service scenario that need to be used when the evaluation model is trained.

The weight value can be negatively correlated to an actual number of modeling samples in each service scenario. In other words, a smaller number of modeling samples indicates that a larger training sample weight is defined.

In this case, a relatively small training sample weight can be set for a certain service scenario with a relatively large number of modeling samples. Similarly, a relatively large training sample weight can be set for a certain service scenario with a relatively small number of modeling samples.

A specific value of the training sample weight can be manually configured by a user based on an actual demand. For example, when modeling samples in multiple service scenarios are merged for centralized modeling, if the user expects that a trained model more focuses on a specified service scenario, the user can manually set a training sample weight of the service scenario to a larger value.

In this example, in a process in which the serving end reads the modeling samples from the modeling sample set to train the evaluation model, the following implementations are used to balance the modeling sample number difference between the service scenarios:

In an implementation, for a service scenario with a relatively large training sample weight, the serving end can preferentially use a modeling sample in the service scenario to participate in modeling. For a service scenario with a relatively small training sample weight, the serving end can properly control a number of used modeling samples in the service scenario based on a specific value of the weight. Therefore, a number of modeling samples that participate in modeling in the service scenario with the relatively large training sample weight tends to be consistent with a number of modeling samples that participate in modeling in the service scenario with the relatively small training sample weight.

In another implementation, for a service scenario with a relatively large training sample weight, by default, the serving end can use all modeling samples in the service scenario to participate in modeling. For a service scenario with a relatively small training sample weight, the serving end can properly repeatedly use a modeling sample in the service scenario based on a specific value of the weight. Therefore, a number of modeling samples that participate in modeling in the service scenario with the relatively large training sample weight tends to be consistent with a number of modeling samples that participate in modeling in the service scenario with the relatively small training sample weight.

As such, impact caused by the modeling sample number difference between the service scenarios on service evaluation accuracy of the final trained service risk model when the service risk model is trained can be alleviated to a maximum extent.

In this example, after the serving end generates the modeling sample set based on the modeling samples collected from the service scenarios, and separately defines the scenario variables for the modeling samples in the modeling sample set, the serving end can use the modeling samples in the modeling sample set as training samples for training based on a predetermined modeling algorithm, to build the evaluation model.

It is worthwhile to note that in practice, the evaluation model is usually an additive model (Additive Model). Therefore, a modeling method used when the serving end trains the evaluation model can be a modeling method of the additive model, for example, a score card or regression analysis.

The additive model in this implementation can usually be expressed to be obtained by adding a model portion formed by basic variables and a model portion formed by scenario variables. After the previously described target data is input into the additive model in this implementation, a corresponding score is obtained for each variable. Therefore, a score obtained by using the additive model in this implementation is usually obtained by adding a sum of corresponding scores of the target data's basic variables in the evaluation model and a corresponding score of the target data's scenario variable in the evaluation model.

Referring to FIG. 2, assume that a score obtained by training the evaluation model is f(X, P), X represents the basic variable, P represents the scenario variable, a corresponding score of the basic variable X in the model is f1(X), and a corresponding score of the scenario variable P in the model is f2(P), AX, P) can be represented as f1(X)+f2(P).

A modeling tool used when the serving end trains the service risk model can be a relatively mature data mining tool, for example, the statistical analysis system (SAS) or statistical product and service solutions (SPSS).

In addition, in this example, details about a specific process of training the evaluation model and a process of evaluating performance of the evaluation model after the evaluation model is trained are omitted in this example. When implementing the technical solutions disclosed in the present application, a person skilled in the art can make references to literatures in the related technologies.

In this example, after the evaluation model is trained, the serving end can collect target data in real time, and perform risk evaluation by using the evaluation model.

When the serving end performs risk evaluation by using the trained evaluation model, collected target data can be service data from any service scenario, and types of variables included in the service sample need to be consistent with types of variables included in a modeling sample. In other words, the target service can also include a scenario variable and several basic variables of the same types as the variables in the modeling sample.

After collecting target data from any service scenario, the serving end can input the target data into the evaluation model, and perform risk evaluation on the target data by using the evaluation model to obtain a corresponding score. The obtained score can be obtained by adding corresponding scores of several basic variables of the target data in the evaluation model and a corresponding score of a scenario variable of the target data in the evaluation model.

In this example, the evaluation model is trained by merging the modeling samples in the service scenarios, and the scenario variables are defined for the modeling samples to distinguish between the service scenarios that the modeling samples belong to. Therefore, different service scenarios are fully considered, so that a score applicable to various different service scenarios can be obtained by performing service risk evaluation by using the evaluation model.

In a shown implementation, if the target data needs to be scored in the multiple modeling scenarios, it needs to be ensured that a score output by the evaluation model is applicable to the multiple modeling scenarios. In this case, the corresponding scores of the basic variables included in the target data in the evaluation model can be output after being added together. A score output in this case is a universal score and is applicable to the multiple different modeling scenarios, and can be used to measure the service risk probability of a user corresponding to the target data in the multiple different service scenarios. Subsequently, the output score can be used in different service scenarios to perform corresponding service procedures.

For example, when the score is a credit score, the output credit score can be separately compared with predetermined thresholds in different loan service scenarios, to determine whether a user corresponding to the credit score is a risk user, and then determine whether to lend money to the user.

It can be seen that the modeling samples in the service scenarios are merged for modeling, so that modeling complexity can be reduced, and modeling does not need to be separately performed for different service scenarios. In addition, the scenario variables are used for the modeling samples, so that the trained evaluation model is applicable to different service scenarios, and a score obtained by performing service risk evaluation by using the service evaluation model can reflect service risk levels of the same user in different service scenarios.

In this example, as previously described, the universal score applicable to the multiple different service scenarios can be obtained by using the model trained by merging the modeling samples in the service scenarios.

However, because the service risk events defined for the service scenarios may be different from each other, the score applicable to the multiple service scenarios that is obtained by performing service risk evaluation by using the evaluation model trained by merging the modeling samples in the service scenarios is usually a relative value, and cannot accurately reflect a service risk level of the same user in a specific service scenario.

In practice, the evaluation model trained by merging the modeling samples in the service scenarios needs to be applicable to different service scenarios, and usually further needs to be able to perform accurate service risk evaluation in a specific service scenario.

For example, the previously described service is a loan service, and the evaluation model is a credit risk evaluation model. Assume that there are three loan service scenarios: credit card services, mortgage services, and car loan services, the evaluation model is trained by merging modeling samples in the three loan service scenarios, and a credit score of a user is obtained by training collected target data based on the evaluation model. In this case, the credit score is a relative value applicable to different loan service scenarios such as credit card services, mortgage services, and car loan services, and cannot accurately reflect a risk level of the same user in a specific loan service scenario.

However, in practice, a user's credit level in any one of loan service scenarios such as credit card services, mortgage services, and car loan services usually further needs to be accurately evaluated. For example, statistics on a percentage of bad credits of the user needs to be accurately collected in any one of the loan service scenarios such as credit card services, mortgage services, and car loan services. In this case, the credit risk evaluation model usually needs to be able to accurately evaluate a credit level of the user in a specific scenario, to obtain a credit score corresponding to the scenario.

In a shown implementation, to enable the evaluation model trained by merging the modeling samples in the service scenarios to be compatible with the characteristic of performing accurate service risk evaluation in a specific service scenario, if the target data needs to be scored in a modeling scenario that the target data belongs to, a score output by the evaluation model usually does not need to be universal, provided that the score is applicable only to the modeling scenario that the target data belongs to. In this case, the corresponding scores of the basic variables included in the target data in the evaluation model and the corresponding score of the scenario variable included in the target data in the evaluation model can be added, and then a sum of the scores can be output. The sum of the scores that is output in this case is a scenario score corresponding to the target data. The score is not universal, and therefore is applicable only to the service scenario that the target data actually belongs to.

It can be seen that as such, when certain target data needs to be scored in a service scenario that the target data actually belongs to, a score applicable to the service scenario that the target data actually belongs to can be obtained only by outputting a sum of corresponding scores of basic variables and a corresponding score of a scenario variable, without separately performing modeling for the service scenario.

The following describes in detail the technical solutions in the previously described implementations with reference to application scenarios of credit risk evaluation.

In this example, the service can be a loan service, the evaluation model can be a credit risk evaluation model, and the score can be a credit score obtained after credit risk evaluation is performed on a collected service sample of a user by using the credit risk evaluation model. The multiple service scenarios can include three loan service scenarios: credit card services, mortgage services, and car loan services.

In an initial state, credit default events can be separately defined for the loan service scenarios. For example, in a credit card crediting scenario, an over-30-day deferred repayment event can be defined as the credit default event. In a mortgage crediting scenario, an over-90-day deferred repayment event can be defined as the credit default event. In a car loan crediting scenario, an over-60-day deferred repayment event can be defined as the credit default event. In other words, the credit default event can be independently defined for each loan scenario.

When collecting modeling samples from the loan service scenarios, the serving end can classify the collected modeling samples into good samples and bad samples based on the credit default events defined for the scenarios. The modeling sample can include variables that affect a credit risk, such as income spending data, historical loan data, and the employment status of a user.

After collecting the modeling samples, the serving end can summarize the modeling samples collected from the loan service scenarios to generate a modeling sample set, and separately define scenario variables for the modeling samples in the modeling sample set based on original basic variables of the modeling samples, to indicate the loan service scenarios that the modeling samples belong to.

When training the credit risk evaluation model, the serving end can merge the modeling samples collected from the scenarios, and train the credit risk evaluation model based on all the modeling samples included in the modeling sample set.

A relatively mature data mining tool, for example, the SAS or SPSS, and a modeling method of an additive model, for example, a score card or regression analysis can be used to complete model training. Details about a specific model training process are omitted in this example.

After the credit risk evaluation model is trained, the serving end can collect target data from any loan service scenario such as credit card services, mortgage services, or car loan services. The collected target data can still include several basic variables and a scenario variable. After the target data is collected, credit scoring can be performed on the target data by using the credit risk evaluation model. Because the credit risk evaluation model is trained by merging the modeling samples in the loan service scenarios such as credit card services, mortgage services, and car loan services, a credit score applicable to multiple loan service scenarios such as credit card services, mortgage services, and car loan services can be obtained by using this model.

Assume that the target data is service data from a specific loan service scenario (credit card), if credit scoring needs to be performed on the target data in the specific loan service scenario (credit card), the serving end can add corresponding credit scores of the several basic variables of the target data in the model and a score of the scenario variable of the target data in the model, and then output a sum of the scores to a user corresponding to the target data as a credit score of the user. The score output in this case is not universal, and therefore is applicable only to the loan service scenario (credit card).

In addition, if credit scoring needs to be performed on the target data in multiple loan service scenarios such as credit card services, mortgage services, and car loan services, the serving end can output corresponding credit scores of the several basic variables of the target data in the model to a user corresponding to the target data as a credit score of the user. The score output in this case is universal, and therefore is applicable to the multiple loan service scenarios such as credit card services, mortgage services, and car loan services.

It can be seen from the previously described implementations that in the present application, the modeling samples are separately collected from the multiple modeling scenarios, the modeling sample set is created based on the modeling samples collected from the multiple service scenarios, and the scenario variables used to indicate the modeling scenarios that the modeling samples belong to are separately defined for the modeling samples in the modeling sample set based on the original basic variables, and then the evaluation model is trained based on the modeling samples in the modeling sample set.

In the present application, the modeling samples in the multiple service scenarios are merged for modeling, and the scenario variables are used for the modeling samples to distinguish between the scenarios of the modeling samples. Therefore, the final trained evaluation model is universal, and therefore a score applicable to multiple different service scenarios can be obtained by using the evaluation model.

If scoring needs to be performed in the service scenario that the target data belongs to, the sum of the corresponding scores of the several basic variables included in the target data in the model and the corresponding score of the scenario variable included in the target data in the model can be output as the score applicable to the service scenario that the target data belongs to.

In addition, if scoring needs to be performed in the multiple service scenarios, the corresponding scores of the several basic variables included in the training data in the model can be output as the score applicable to the multiple different service scenarios. Therefore, the model can output not only the universal score but also the score applicable to the service scenario that the target data actually belongs to. As such, scores are more flexibly output and are applicable to different scoring scenarios.

Corresponding to the previously described method implementations, the present application further provides a device implementation.

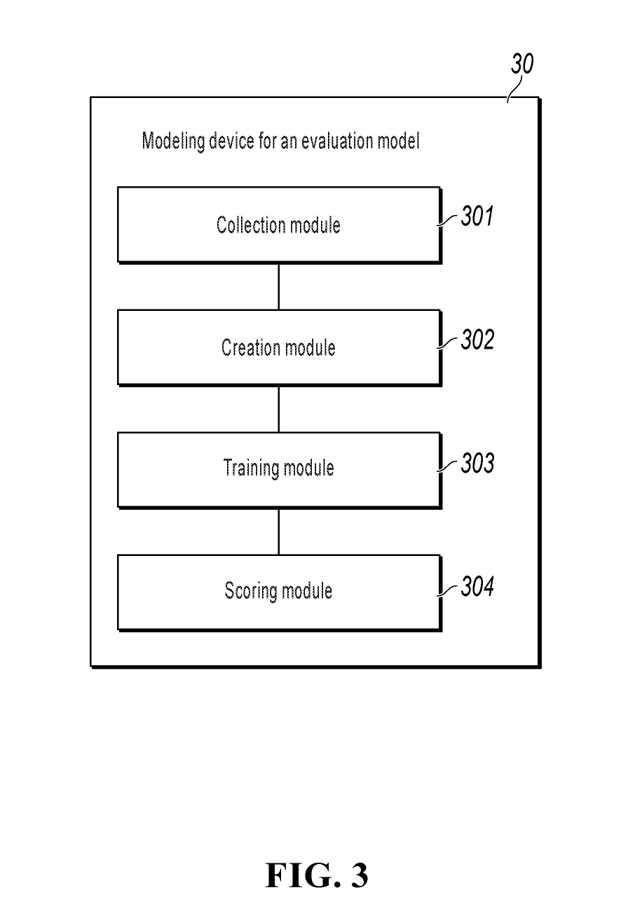

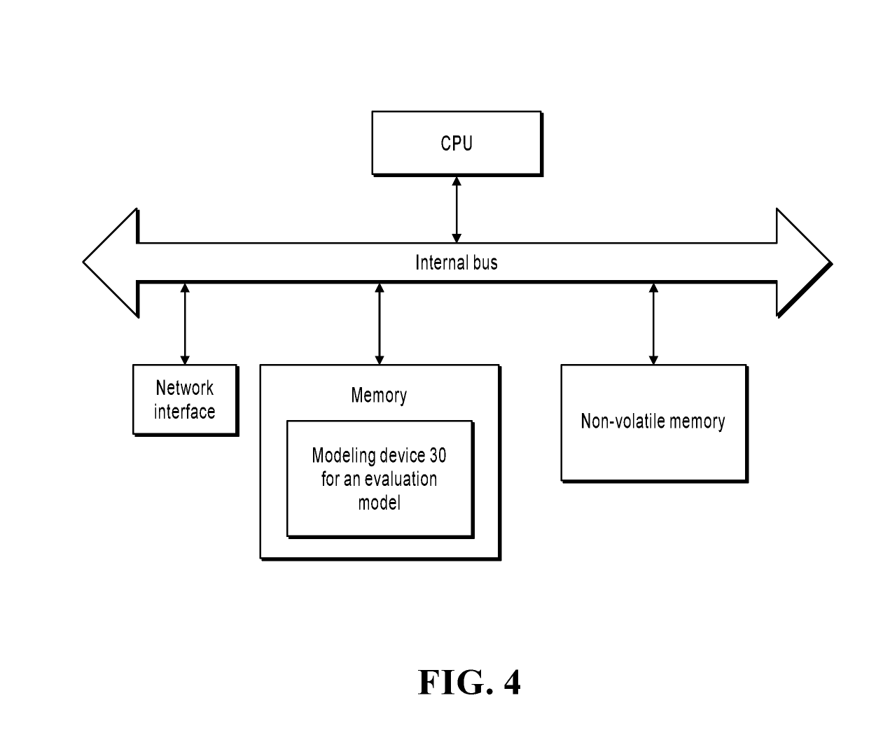

Referring to FIG. 3, the present application provides a modeling device 30 for an evaluation model, applied to a serving end. Referring to FIG. 4, a hardware architecture of a serving end that includes the modeling device 30 for an evaluation model generally includes a CPU, a memory, a nonvolatile memory, a network interface, an internal bus, etc. For example, during software implementation, the modeling device 30 for an evaluation model can usually be understood as a logical device with a combination of software and hardware that is formed after a computer program loaded in the memory runs on the CPU. The device 30 includes a collection module 301, configured to separately collect modeling samples from multiple modeling scenarios, where the modeling sample includes a scenario variable and several basic variables, and the scenario variable indicates a modeling scenario that the modeling sample belongs to; a creation module 302, configured to create a modeling sample set based on the modeling samples collected from the multiple modeling scenarios; and a training module 303, configured to train an evaluation model based on the modeling samples in the modeling sample set, where the evaluation model is an additive model, and the evaluation model is obtained by adding a model portion formed by basic variables and a model portion formed by scenario variables.

In this example, the creation module 302 is further configured to define a training sample weight for each modeling scenario based on a number of modeling samples in each modeling scenario, where the training sample weight is used to balance a modeling sample number difference between the modeling scenarios, and a smaller number of modeling samples in a modeling scenario indicates that a larger training sample weight is defined for the scenario.

In this example, the collection module 301 is further configured to collect target data, where the target data includes a scenario variable and several basic variables.

The device 30 further includes a scoring module 304, configured to input the target data into the evaluation model, to obtain a target data score, where the score is obtained by adding corresponding scores of the several basic variables in the evaluation model and a corresponding score of the scenario variable in the evaluation model.

In this example, the scoring module 304 is further configured to output a sum of the corresponding scores of the several basic variables in the evaluation model and the corresponding score of the scenario variable in the evaluation model as a score applicable to a modeling scenario that the target data belongs to, if the target data needs to be scored in the modeling scenario that the target data belongs to.

In this example, the scoring module 304 is further configured to output the corresponding scores of the several basic variables in the evaluation model as a score applicable to the multiple modeling scenarios, if the target data needs to be scored in the multiple modeling scenarios.

A person skilled in the art can easily figure out other implementation solutions of the present application after considering the specification and practicing the present application disclosed here. The present application is intended to cover any variations, functions, or adaptive changes of the present application. These variations, functions, or adaptive changes comply with general principles of the present application, and include common knowledge or a commonly used technical means in the technical field that is not disclosed in the present application. The specification and the implementations are merely considered as examples, and the actual scope and the spirit of the present application are described in the following claims.

It is worthwhile to understand that the present application is not limited to the previously described accurate structures shown in the accompanying drawings, and various modifications and changes can be made to the present application without departing from the scope of the present application. The scope of the present application is limited only by the appended claims.

The previous descriptions are merely example implementations of the present application, but are not intended to limit the present application. Any modification, equivalent replacement, improvement, etc. made without departing from the spirit and principle of the present application should fall within the protection scope of the present application.

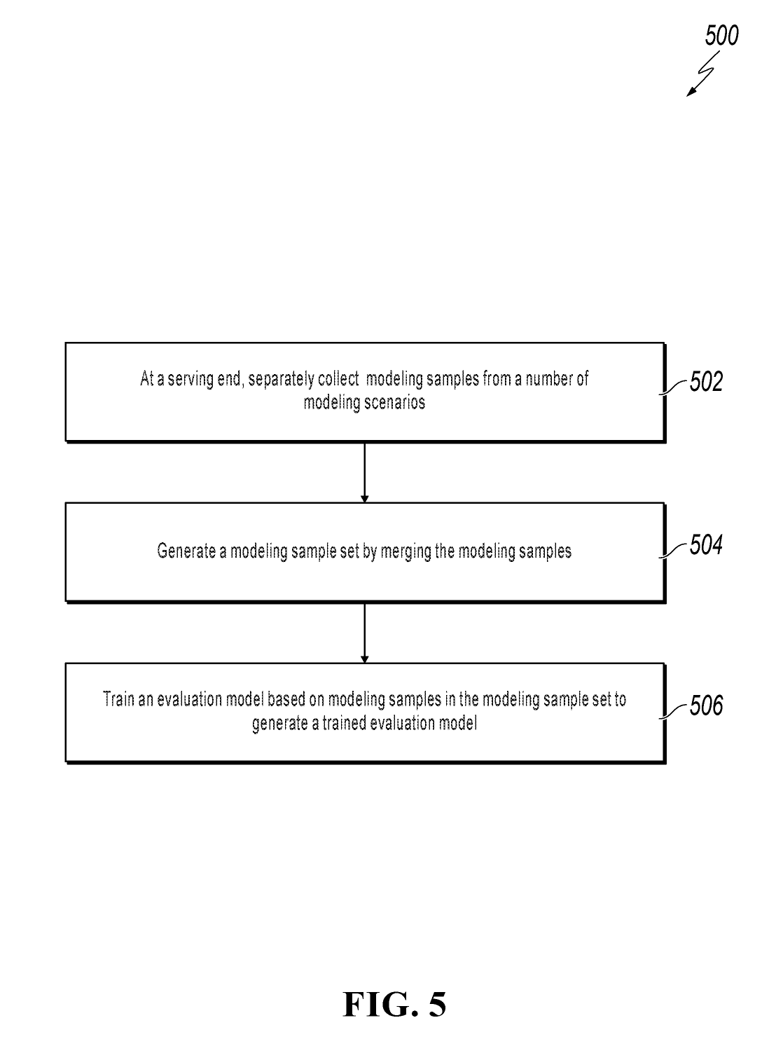

FIG. 5 is a flowchart illustrating an example of a computer-implemented method 500 for generating and training an evaluation model, according to an implementation of the present disclosure. For clarity of presentation, the description that follows generally describes method 500 in the context of the other figures in this description. However, it will be understood that method 500 can be performed, for example, by any system, environment, software, and hardware, or a combination of systems, environments, software, and hardware, as appropriate. In some implementations, various steps of method 500 can be run in parallel, in combination, in loops, or in any order.

At 502, at a serving end, modeling samples are separately collected from a number of modeling scenarios, where each modeling sample includes a scenario variable and several of basic variables, and where the scenario variable indicates a modeling scenario that the modeling sample belongs to. From 502, method 500 proceeds to 504.

At 504, a modeling sample set is generated by merging the collected modeling samples. In some implementation, generating the modeling sample set includes separately defining, for each scenario, a plurality of risk events; classifying the collected modeling samples into good samples and bad samples by determining whether each collected modeling sample includes at least one of the risk event; and summarizing the collected modeling samples to generate a modeling sample set. From 504, method 500 proceeds to 506.

At 506, an evaluation model is trained based on modeling samples in the modeling sample set to generate a trained evaluation model, where the trained evaluation model is universal, and where the trained evaluation model is configured to produce a score applicable to multiple service scenarios.

In some implementation, the evaluation model is an additive model, and where the evaluation model is built by adding a first model portion formed by basic variables and a second model portion formed by scenario variables.

In some implantations, method 500 further includes defining a training sample weight for each modeling scenario based on a number of modeling samples in each modeling scenario.

In some implementations, method 500 further includes collecting target data from a specific service scenario, where the target data includes a scenario variable and a plurality of basic variables; inputting the target data to the trained evaluation model; and outputting a score for the target data, where the score is universal if the target data scored in multiple service scenarios, and where the score is not universal if the target data scored in the specific service scenario the target data belongs to.

In such implementation, the target data scored in the service scenario that the target data belongs to, and where the output score of the trained evaluation model is a sum of the corresponding scores of the basic variables of the target data in the evaluation model and a score of the scenario variable of the target data in the evaluation model.

In such implementation, the target data scored in multiple service scenarios, and wherein the output score of the trained evaluation model is a sum of corresponding scores of the plurality of basic variables of the target data in the evaluation model. After 506, method 500 stops.

Implementations of the present application can solve technical problems in generating and training an evaluation model. In some cases, to generate an evaluation model, for example, a service risk model, a large amount of service data is first collected from a certain service scenario as modeling samples, and then trained by using a stastics selection model or a machine leaning model to build a service risk model. After the service risk model is built, target service data can be input into the service risk model to perform risk evaluation and to predict the probability of the service risk event. Then, the probability can be converted into corresponding service score, to reflect a service risk level. However, in practice, when there are a large number of service scenarios, a service score obtained by performing service risk evaluation using a service risk model built for a single scenario may not be not universal, and therefore may be inapplicable to multiple different service scenarios. What is needed is a technique to bypass these problems in the conventional methods, and providing a more uniformed and method to generate and train an evaluation model, so that the trained evaluation model is universal, and a score obtained by using this trained evaluation model is applicable to a large number of service scenarios.

Implementation of the present application provide methods and apparatuses for improving data processing by generating and training a universal evaluation model. According to these implementations, model samples are separately collected from multiple modeling scenarios, a modeling sample set is created based on the modeling samples collected from the multiple scenarios, and scenario variables used to indicate the modeling scenarios that the modeling samples belong to are separately defined for the modeling samples in the modeling sample set based on original basic variables, and then an evaluation model is trained based on the modeling samples in the modeling sample set. The described subject matter provides several technical advantages. For example, because the modeling samples in the service scenarios are merged for modeling, the modeling and subsequent data computation complexity can be reduced, and modeling does not need to be separately performed for different service scenarios, improving the modeling and data processing speed and efficiency. In addition, because the scenario variables are used for the modeling samples, the trained evaluation model is applicable to different service scenarios, and a score obtained by performing service risk evaluation by using the service evaluation model can reflect risk levels of the same user in different service scenarios.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
separately collecting, at a serving end, modeling samples from a plurality of modeling scenarios, wherein each modeling sample includes a scenario variable and a plurality of basic variables, and wherein the scenario variable indicates a modeling scenario that the modeling sample belongs to;
generating a modeling sample set by merging the modeling samples; and
training an evaluation model based on modeling samples in the modeling sample set to generate a trained evaluation model, wherein the trained evaluation model is universal, and wherein the trained evaluation model is configured to produce a score applicable to multiple service scenarios.

2. The computer-implemented method of claim 1, wherein the evaluation model is an additive model, and wherein the evaluation model is built by adding a first model portion formed by basic variables and a second model portion formed by scenario variables.

3. The computer-implemented method of claim 1, wherein generating the modeling sample set includes:
separately defining, for each modeling scenario, a plurality of risk events;
classifying the modeling samples into good samples and bad samples by determining whether each collected modeling sample includes at least one of the risk events; and
summarizing the collected modeling samples to generate a modeling sample set.

4. The computer-implemented method of claim 1, further comprising:
defining a training sample weight for each modeling scenario based on a number of modeling samples in each modeling scenario.

5. The computer-implemented method of claim 1, further comprising:
collecting target data from a specific service scenario, wherein the target data includes a scenario variable and a plurality of basic variables;
inputting the target data to the trained evaluation model; and
outputting a score for the target data, wherein the score is universal if the target data scored in multiple service scenarios, and wherein the score is not universal if the target data scored in the specific service scenario the target data belongs to.

6. The computer-implemented method of claim 5, wherein the target data scored in the service scenario that the target data belongs to, and wherein the score of the trained evaluation model is a sum of the corresponding scores of the basic variables of the target data in the evaluation model and a score of the scenario variable of the target data in the evaluation model.

7. The computer-implemented method of claim 5, wherein the target data scored in multiple service scenarios, and wherein the output score of the trained evaluation model is a sum of corresponding scores of the plurality of basic variables of the target data in the evaluation model.

8. A non-transitory, computer-readable medium storing one or more instructions executable by a computer system to perform operations comprising:
separately collecting, at a serving end, modeling samples from a plurality of modeling scenarios, wherein each modeling sample includes a scenario variable and a plurality of basic variables, and wherein the scenario variable indicates a modeling scenario that the modeling sample belongs to;
generating a modeling sample set by merging the modeling samples; and
training an evaluation model based on modeling samples in the modeling sample set to generate a trained evaluation model, wherein the trained evaluation model is universal, and wherein the trained evaluation model is configured to produce a score applicable to multiple service scenarios.

9. The non-transitory, computer-readable medium of claim 8, wherein the evaluation model is an additive model, and wherein the evaluation model is built by adding a first model portion formed by basic variables and a second model portion formed by scenario variables.

10. The non-transitory, computer-readable medium of claim 8, wherein generating the modeling sample set includes:
separately defining, for each scenario, a plurality of risk events;
classifying the collected modeling samples into good samples and bad samples by determining whether each collected modeling sample includes at least one of the risk event; and
summarizing the collected modeling samples to generate a modeling sample set.

11. The non-transitory, computer-readable medium of claim 8, the operations further comprising:
defining a training sample weight for each modeling scenario based on a number of modeling samples in each modeling scenario.

12. The non-transitory, computer-readable medium of claim 8, the operations further comprising:
collecting target data from a specific service scenario, wherein the target data includes a scenario variable and a plurality of basic variables;
inputting the target data to the trained evaluation model; and
outputting a score for the target data, wherein the score is universal if the target data scored in multiple service scenarios, and wherein the score is not universal if the target data scored in the specific service scenario the target data belongs to.

13. The non-transitory, computer-readable medium of claim 12, wherein the target data scored in the service scenario that the target data belongs to, and wherein the output score of the trained evaluation model is a sum of the corresponding scores of the basic variables of the target data in the evaluation model and a score of the scenario variable of the target data in the evaluation model.

14. The non-transitory, computer-readable medium of claim 12, wherein the target data scored in multiple service scenarios, and wherein the output score of the trained evaluation model is a sum of corresponding scores of the plurality of basic variables of the target data in the evaluation model.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
separately collecting, at a serving end, modeling samples from a plurality of modeling scenarios, wherein each modeling sample includes a scenario variable and a plurality of basic variables, and wherein the scenario variable indicates a modeling scenario that the modeling sample belongs to;
generating a modeling sample set by merging the modeling samples; and
training an evaluation model based on modeling samples in the modeling sample set to generate a trained evaluation model, wherein the trained evaluation model is universal, and wherein the trained evaluation model is configured to produce a score applicable to multiple service scenarios.

16. The computer-implemented system of claim 15, wherein the evaluation model is an additive model, and wherein the evaluation model is built by adding a first model portion formed by basic variables and a second model portion formed by scenario variables.

17. The computer-implemented system of claim 15, wherein generating the modeling sample set includes:
separately defining, for each scenario, a plurality of risk events;
classifying the collected modeling samples into good samples and bad samples by determining whether each collected modeling sample includes at least one of the risk event; and
summarizing the collected modeling samples to generate a modeling sample set.

18. The computer-implemented system of claim 15, further comprising:
defining a training sample weight for each modeling scenario based on a number of modeling samples in each modeling scenario.

19. The computer-implemented system of claim 15, the operations further comprising:
collecting target data from a specific service scenario, wherein the target data includes a scenario variable and a plurality of basic variables;
inputting the target data to the trained evaluation model; and
outputting a score for the target data, wherein the score is universal if the target data scored in multiple service scenarios, and wherein the score is not universal if the target data scored in the specific service scenario the target data belongs to.

20. The computer-implemented system of claim 19, wherein the target data scored in multiple service scenarios, and wherein the output score of the trained evaluation model is a sum of corresponding scores of the plurality of basic variables of the target data in the evaluation model.
